(19) United States
(12) Patent Application Publication
(10) Pub. No.: US 2018/0165631 A1
(43) Pub. Date: Jun. 14, 2018

(54) COMPUTER-IMPLEMENTED SYSTEM AND METHODS FOR SECURE PACKAGE DELIVERY

(71) Applicant: ID Lock Smart, LLC, Rehoboth Beach, DE (US)

(72) Inventors: Alberto Romero, York, PA (US); Michael Watroba, York, PA (US); Jeff Sager, Dallastown, PA (US); Patrick Maher, Dallastown, PA (US)

(73) Assignee: ID Lock Smart, LLC, Rehoboth Beach, DE (US)

(21) Appl. No.: 15/378,340

(22) Filed: Dec. 14, 2016

(51) Int. Cl. G06Q 10/08; G06F 17/30; G07C 9/00; G08B 13/196; G08B 13/08

(52) U.S. Cl. CPC G06Q 10/0833; G06F 17/30876; G07C 9/00571; H04L 67/42; G08B 13/19665; G08B 13/08; G08B 13/19697

(57) ABSTRACT

In some embodiments, a secure package delivery system and methods may include a door lock smart device in communication with a system server, a delivery information device in communication with the system server, and a client device in communication with the system server. The delivery information device may provide delivery status information of a package to the system server. The door lock smart device may govern access to a door at the location to which the package is to be delivered. The system server may, in response to receiving the delivery status information of the package from the delivery information device, communicate with the door lock smart device to enable access to the door governed by the door lock smart device. The system server may also be configured to communicate delivery completion information to the client device.

### FIELD OF THE INVENTION

This patent specification relates to the field of ensuring the secure delivery of a package to a location. More specifically, this patent specification relates to systems and methods that are configured to enable a package to be delivered into a secure location and to provide information which describes the delivery of the package.

### BACKGROUND

E-commerce has traditionally been accomplished utilizing package delivery companies which frequently deliver packages to homes when the recipient is not home. However, a common practice of package delivery involves the requirement for the delivery companies to either receive a signature from the intended recipient of the package or their agent or to leave the package at the door where it is susceptible to theft. If the recipient is not home for a package requiring a signature, the delivery company has to arrange to bring the package back in one or more subsequent delivery attempts resulting in loss of time and the cost of additional fuel which can further result in loss of profit to the delivery company.

While there exists systems, methods, and devices for receiving packages on behalf of the recipient, they all have drawbacks which limit their usefulness, such as having to rely on a third party to accept the package on the recipient's behalf, requiring large and expensive enclosures into which a package may be placed and secured, and relying on frequent communications with the recipient which can be annoying and time consuming.

Therefore, a need exists for novel systems and methods for secure package delivery. A further need exists for novel systems and methods for secure package delivery which allow the delivery company to deliver the package securely into a location such as the recipient's home. Finally, a need exists for novel systems and methods for secure package delivery which do not require the delivery company to have to arrange to bring the package back in one or more subsequent delivery attempts if the recipient is not available.

### BRIEF SUMMARY OF THE INVENTION

A computer-implemented system and methods of providing location entry for secure package delivery are disclosed. The system and methods may enable secure delivery of a package into a location specified by a package recipient user without requiring the package recipient user to be present when the package is delivered.

In some embodiments, a secure package delivery system may include a door lock smart device in communication with a system server, a delivery information device in communication with the system server, and a client device in communication with the system server. The delivery information device may be configured to provide delivery status information of a package to the system server. The door lock smart device may be configured to govern access to a door at the location to which the package is to be delivered. Optionally, the door lock smart device may be configured to provide information describing the opening and closing of the door to the system server. The system server may be configured to, in response to receiving the delivery status information of the package from the delivery information device, communicate with the door lock smart device to enable access to the door governed by the door lock smart device. The system server may also be configured to communicate delivery completion information which includes information describing the opening and closing of the door to the client device.

In some embodiments, a secure package delivery method may include the steps of: receiving delivery information which includes the delivery location for a package; receiving communication protocols for a door lock smart device which controls access to an access door at the delivery location; receiving delivery status information which includes the location of the package; determining that the delivery information matches the delivery status information; communicating, via the received communication protocols, with the door lock smart device to grant access to the access door in response to the package being proximate to the delivery location; and communicating, via the received communication protocols, with the door lock smart device to restrict access to the access door.

In further embodiments, the method may include the step of communicating delivery completion information to a client device. The delivery completion information may include information describing the opening and closing of the door which the door lock smart device controls access to and/or a recording of the area proximate to the door governed by a door lock smart device

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for secure package delivery according to various embodiments described herein.

FIG. 2 illustrates a block diagram showing an example of a some of the components and computer implemented methods which may be found in a system for secure package delivery according to various embodiments described herein.

FIG. 3 shows a block diagram showing an example of a system server which may be used by the system as described in various embodiments herein.

FIG. 4 depicts a block diagram illustrating an example of a client device which may be used by the system as described in various embodiments herein.

FIG. 5 illustrates a block diagram of an example of a method of providing location entry for secure package delivery according to various embodiments described herein.

FIG. 6 shows a block diagram of an example of a method for notifying package recipient of secure package delivery according to various embodiments described herein.

FIG. 7 depicts a block diagram of an example of a method for secure package delivery according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, delivery information devices, smart devices, client devices, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” or sometimes “electronic device” or just “device” as used herein is a type of computer generally operated by a person or user of the system. In some embodiments, a client device is a smartphone or computer configured to receive and transmit data to a server or other electronic device which may be operated locally or in the cloud. Non-limiting examples of client devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “smart device” as used herein refers to any electronic device, generally connected to other devices or networks via different wireless protocols such as Bluetooth, NFC, WiFi, 3G, etc., that can operate to some extent interactively and autonomously. Several notable types of smart devices include smartphones (like the Apple iPhone or most of the devices running Android operating system), phablets and tablets (like the Apple iPad or Google Nexus 7), smartwatches, smart bands and smart keychains (as Prestigio Keys). The term can also refer to a ubiquitous computing device: a device that exhibits some properties of ubiquitous computing including—although not necessarily—artificial intelligence. Additionally, smart device may refer to electronic devices which may be used for home automation systems which use computer and information technology to control home appliances and features (such as windows or lighting). Systems can range from simple remote control of lighting through to complex computer/micro-controller based networks with varying degrees of intelligence and automation. Several notable types of smart devices include remotely operated door locks, security systems, security cameras, microphones, and other recording equipment, smart appliances, smart light bulbs and lighting, smart thermostats, intercoms, domotics, smart shading, and the like.

The term “delivery information device” as used herein refers to any electronic device, generally connected to other devices or networks via different wireless protocols, such as Bluetooth, NFC, WiFi, cellular/wireless/cordless telecommunication protocols (e.g. 3G/4G, etc.), satellite data communication protocols, which may be operated by an individual such as a delivery agent who may be employed or contracted by a delivery vendor. The delivery information device may provide tracking information for one or more packages to the system. For example, a delivery information device may be a delivery information acquisition device (DIAD) commonly used by UPS delivery drivers/agents. As another example, a delivery information device may be a smartphone, tablet computer, laptop computer or the like, which may be operated by a delivery agent. In a further example, a delivery information device may be a GPS enabled tracking device which automatically updates and provides delivery information such as when the delivery agent's vehicle is at or proximate to the delivery location.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New systems and methods for providing secure package delivery to a location are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

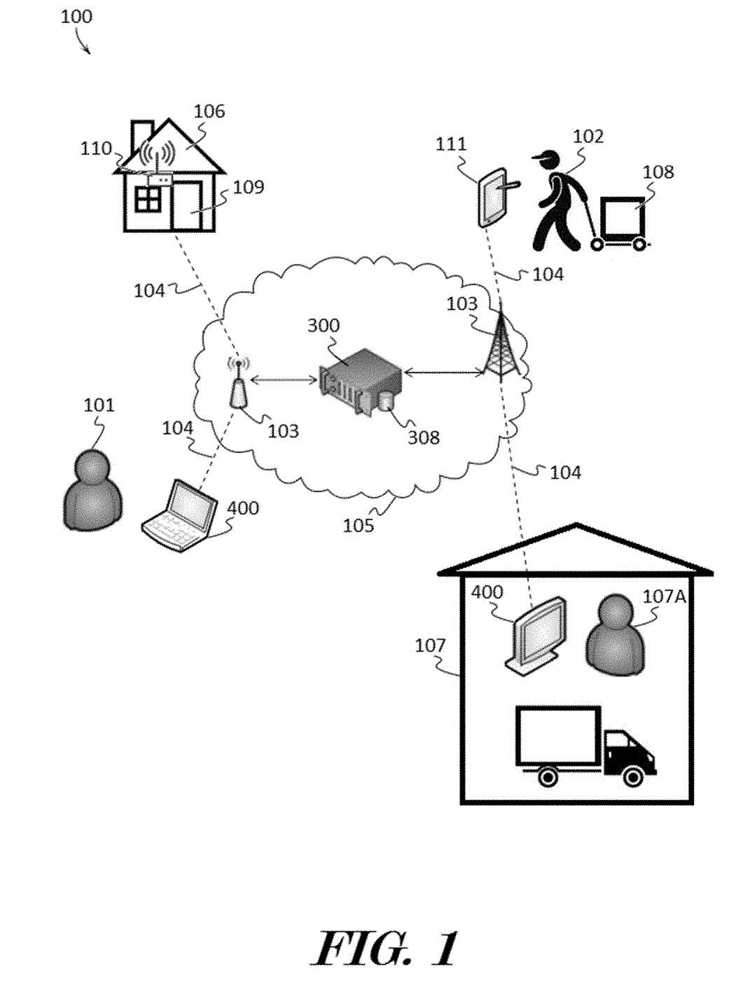

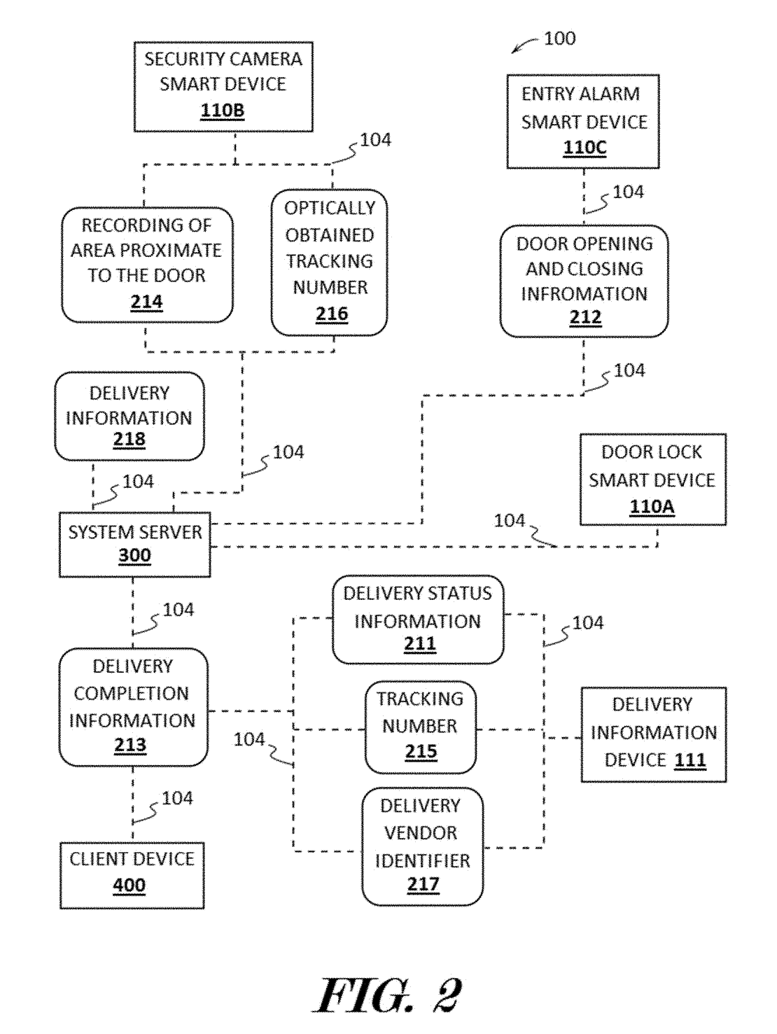

The present invention will now be described by example and through referencing the appended figures representing preferred and alternative embodiments. As perhaps best shown by FIGS. 1 and 2, an illustrative example of some of the physical components which may comprise a system for secure package delivery (“the system”) 100 according to some embodiments is presented. The system 100 is configured to facilitate the transfer of data and information between one or more access points 103, package recipient users 101 via their client device 400, delivery agents 102 via their delivery information device 111, locations 106, delivery vendors 107, delivery vendor users 107A, and servers 300 over a data network 105 through a network connection 104. A data store 308 accessible by the server 300 may contain one or more databases.

Generally, a package recipient user 101 may be an individual to whom a package 108 is to be delivered to. In order to be delivered, the package 108 is associated with delivery location 106 such as a home or business. Typically, delivery of the package 108 is managed by a delivery vendor 107, such as the United States Postal Service (USPS), United Parcel Service (UPS), and FedEx Corporation, that may employ or contract one or more delivery agents 102 to physically deliver packages 108 to locations 106. Optionally, a delivery vendor 107 may also employ one or more delivery vendor users 107A who may not physically deliver packages 108 to locations 106, but may otherwise facilitate the delivery process.

The data transferred by the system 100 may comprise any information that one or more users desire to input into the system 100 including information describing one or more package recipient users 101 and their client devices 400, information describing a location 106 and any smart devices 110 at the location, information describing one or more packages 108, information describing one or more delivery agents 102 of a delivery vendor 107, information describing one or more delivery vendors 107, and any other information which a user may desire to input or enter into the system 100. In further embodiments, data transferred by the system 100 may comprise delivery status information 211, information describing the opening and closing of the door 212, delivery completion information 213, one or more recordings of an area proximate to one or more doors 214, one or more tracking numbers 215 for one or more packages 108, one or more optically obtained tracking number 216 for one or more packages 108, and/or delivery vendor identifier 217 information.

In this example, the system 100 comprises at least one client device 400 (but preferably more than two client devices 400) configured to be operated by one or more users such as a package recipient user 101 and a delivery vendor user 107A. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

The system 100 is configured enable secure delivery of a package 108 to a location 106 specified by a package recipient user 101 without requiring the package recipient user 101 to interact with the delivery agent 102 that is tasked with delivery of said package 108. In some embodiments, the delivery vendor 107 or delivery vendor user 107A may task a delivery agent 102 with securely delivering a package 108 to a location 106 specified by a package recipient user 101. The package recipient user 101 may be an individual that has ordered or been gifted one or more items which may be contained in a package 108. For example, the package recipient user 101 may have ordered an expensive tablet computer which may be contained in a package 108.

In some embodiments, the location 106, such as a home or business, may have one or more smart devices 110, such as remotely operated door locks, security systems, security cameras, microphones, and other recording equipment, which may be installed at the location and which may be in contact with the data network 105 of the system 100 through a network connection 104. The smart devices 110, server 300, and/or client devices 400 may utilize any type of network connection 104, such as a Z-Wave wireless communications protocol, a ZigBee IEEE 802.15.4-based wireless communications protocol, a WiFi wireless communications protocol, Bluetooth wireless communications protocol, any other wireless communications protocol, and/or one or more wired type network connection 104, to enable electronic communication between them.

In further embodiments, the location 106 may comprise a remotely operated door lock smart device 110A type of smart device 110 which may enable the access door 109 of the location 106 to be locked and unlocked. In still further embodiments, the location 106 may comprise a security camera smart device 110B type of smart device 110 which may be configured to provide video and/or audio recordings of one or more areas of the location 106 such as an area proximate to the access door 109. In still further embodiments, the location 106 may comprise an entry alarm smart device 110C type of smart device 110 which may include one or more alarms sensors which may be configured to determine if the access door 109 of the location 106 is open or closed.

Generally, each package 108 may be associated with delivery information 218 or instructions which may contain information such as the address of the location 106 to which the package 108 is to be delivered, a tracking number 215 associated with the package 108, the name of the package recipient user 101, contact information of the package recipient user 101 which may be used to communicate with the client device 400 of the package recipient user 101, a delivery vendor identifier 217, and the like, which may optionally be printed or otherwise attached to the exterior of the package 108. The delivery vendor 107 may receive or create the package 108 and task a delivery agent 102 with secure delivery of the package 108 to a location 106. In preferred embodiments, the package recipient user 101 may provide information to the delivery vendor 107 which describes one or more smart devices 110, such as door lock smart devices 110A, security camera smart devices 110B, and/or entry alarm smart devices 110C, installed at the delivery location 106. This information may enable the system server 300 to operate and/or communicate with the one or more smart devices 110 installed at the delivery location 106.

Once the delivery agent 102 is at or proximate to the location 106 to which the package 108 is to be delivered, a delivery information device 111 of the delivery agent 102 may provide this information as delivery status information 211 to the system server 300. In some embodiments, the delivery information device 111 of the delivery agent 102 may provide delivery status information 211 to the secure delivery application 321 of the system server 300 which includes the location of the package 108, a tracking number 215 of the package 108, and/or a delivery vendor identifier 217. The delivery vendor identifier 217 may be any type of information which may identify the delivery agent 102/delivery vendor 107 as the entity tasked with delivering the package 108 to the location 106.

Once the delivery status information 211 is received, the system server 300 may then operate the one or more smart devices 110 installed at the delivery location 106. For example, the system server 300 may operate a door lock smart device 110A to unlock the access door 109, operate an entry alarm smart device 110C to disable the entry alarm on the access door 109, and/or operate a security camera smart device 110B to record the area proximate to the access door 109 at the location 106. In some embodiments, the delivery agent 102 may then enter the location 106 through the access door 109 to place the package 108 within the location. In other embodiments, the delivery agent 102 may simply open the access door 109 to place the package 108 within the location 106.

In some embodiments, upon delivery completion of the package 108 within the location 106, the delivery information device 111 of the delivery agent 102 and/or one or more smart devices 110 at the location 106 may provide information to the system server 300 and the system server 300 may then operate the one or more smart devices 110 installed at the delivery location 106. In other embodiments, the system server 300 may operate the one or more smart devices 110 installed at the delivery location 106 after a time period has passed that may be typically required for a package 108 to be placed within the location 106. Continuing the above example, the system server 300 may operate or communicate with the one or more smart devices 110 installed at the delivery location 106 by operating the door lock smart device 110A to lock the access door 109, operating the entry alarm smart device 110C to enable the entry alarm on the access door 109, and/or operating the security camera smart device 110B to stop recording the area proximate to the access door 109 at the location 106.

Additionally, the system server 300 may operate or communicate with the one or more smart devices 110 installed at the delivery location 106 to receive information and data from the smart devices 110. In some embodiments, the system server 300 may receive data or information from a door lock smart device 110A describing when the access door 109 was opened and closed 212, locked, and/or unlocked. In further embodiments, the system server 300 may receive data from an entry alarm smart device 110C describing when the access door 109 was opened or closed to enable the entry alarm on the access door 109. In further embodiments, the system server 300 may receive data from an entry alarm smart device 110C describing a time period when the entry alarm smart device 110C was prevented from creating an alarm. In still further embodiments, the system server 300 may receive data from a security camera smart device 110B which includes a recording of the area proximate to the door 214 governed by the door lock smart device 110A. In still further embodiments, the system server 300 may receive data from a security camera smart device 110B which includes an optically obtained tracking number 216.

In preferred embodiments, the system 100 may provide delivery completion information 213 which includes information describing the delivery of the package 108 to the client device 400 of the package recipient user 101. In some embodiments, this delivery completion information 213 may be used to form a notification to the client device 400 of the package recipient user 101 indicating that the delivery information device 111 of the delivery agent 102, and therefore the delivery agent 102, is proximate to the location 106 to which the package 108 is to be delivered. In some embodiments, this delivery completion information 213 may be used to form a notification to the client device 400 of the package recipient user 101 indicating that the system 100 has or will operate the one or more smart devices 110 installed at the delivery location 106. In further embodiments, this delivery completion information 213 may be used to form a notification to the client device 400 of the package recipient user 101 indicating that the package recipient user 101 may view information recorded or provided by the one or more smart devices 110 installed at the delivery location 106 which describes the package 108 being placed within the location 106 by the delivery agent 102. In still further embodiments, this delivery completion information 213 may comprise information recorded or provided by the one or more smart devices 110 installed at the delivery location 106 which describes the package 108 being placed within the location 106 by the delivery agent 102.

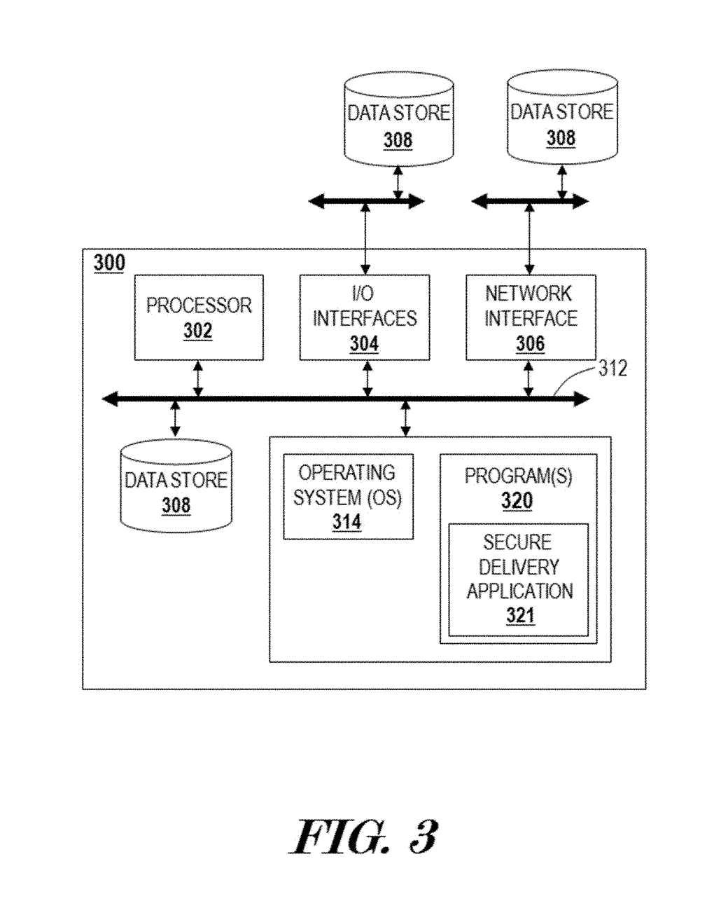

Referring now to FIG. 3, in an exemplary embodiment, a block diagram illustrates a system server 300 of which one or more may be used in the system 100 or standalone. The system server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the system server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

The one or more programs 320 may be configured to implement the various processes, algorithms, methods, techniques, etc. described herein. In some embodiments, the programs 320 of the system server 300 may include a secure delivery application 321 which may perform one or more functions of the system 100 and which may be executed by a computing device processor, such as a processor 302.

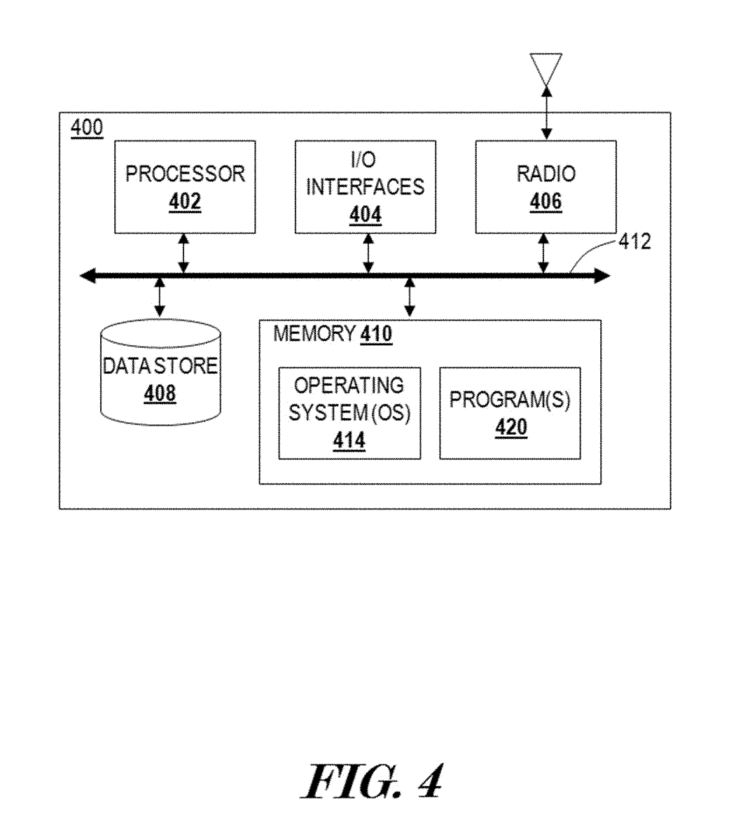

Referring to FIG. 4, in an exemplary embodiment, a block diagram illustrates a client device 400 of which one or more may be used in the system 100 or the like. In some embodiments, a smart device 110 and a delivery information device 111 may each be a type of client device 400. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 4 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); Z-Wave wireless communications protocol used primarily for home automation; IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

A door lock smart device 110A may be a type of client device 400 which may govern access to an access door 109 at a location 106 and which may be in communication with the system server 300. In some embodiments, a door lock smart device 110A may be engaged to an access door 109 at a location 106 and be configured to lock and unlock the access door 109 to restrict and grant access to the access door 109. In further embodiments, a door lock smart device 110A may be configured to provide information to the system server 300 which may include times or time periods in which the access door 109 was opened, closed, locked, and/or unlocked.

In some embodiments, a door lock smart device 110A may be engaged to a human sized access door 109 which may allow a human to enter and exit a building such as a home, office, business, or the like. A door lock smart device 110A may be an internet-connected door lock that offers sophisticated “access control” features to any home or business. Proximity sensors like Bluetooth and NFC can unlock an access door 109 to which the door lock smart device 110A is engaged to whenever an authorized user's smartphone or client device 400 approaches. Users can also remotely lock and unlock the door 109, or share access with any number of others, using mobile apps. Physical keypads provide a backup with many locks, but are no longer a requirement for entry. Example door lock smart devices 110A include August®, Danalock®, LockState RemoteLock®, Schlage Sense®, Yale Real Living Deadbolt®, and the like.

In other embodiments, a door lock smart device 110A may be a secure lockbox having a first access door 109 which may govern access to a compartment that may be shaped to contain a key which may be used to lock and unlock a second access door 109 which may allow a human to enter and exit a building such as a home, office, business, or the like. In this manner, by granting and restricting access to the first access door 109 of a key compartment and a key within, a secure lockbox type of door lock smart device 110A may grant and restrict access to a second access door 109 which may allow a human to enter and exit a building. Examples secure lockbox type of door lock smart devices 110A include Supra® electronic keyboxes and the like.

A security camera smart device 110B may be a type of client device 400 which may be in communication with the system server 300 and which may be configured to create recordings, with sound and/or video data, preferably of an area proximate to the access door 109 governed by a door lock smart device 110A so that the security camera smart device 110B may create recordings of individuals proximate to and/or that access the access door 109. A security camera smart device 110B may be a stand-alone device or integrated with a entry alarm smart device 110C. Example security camera smart devices 110B include Nest Cam Outdoor®, Nest Cam Indoor®, Canary All-In-One Home Security Device®, Blink Home Security Camera System®, and the like.

In some embodiments, a security camera smart device 110B may be configured to record a package 108 and a tracking number 215 printed or otherwise affixed on the package 108. In this manner, the security camera smart device 110B may provide the tracking number 215 as an optically obtained tracking number 216 to the system server 300 which may then convert or extract the tracking number 215 from the optically obtained tracking number 216 such as through Optical Character Recognition (OCR) processing.

An entry alarm smart device 110C may be a type of client device 400 which may be in communication with the system server 300 and which may be configured to function as an alarm system for the access door 109 and the building to which the door lock smart device 110A and/or security camera smart device 110B may be engaged to. Typically, an entry alarm smart device 110C may be configured to provide an audible and/or electronic alarm if an access door 109 is opened without deactivating the entry alarm smart device 110C. Example entry alarm smart devices 110C include iSmartAlarm® Premium Package, SimpliSafe® Home Security System, Vivint Sky®, SkylinkNet® Alarm System Starter Kit (SK-200), Netgear Arlo® Security System, Canary All-In-One Home Security Device®, Icontrol® Networks Piper NV, and the like.

In some embodiments, entry alarm smart device 110C may be configured to determine if the door 109 governed by the door lock smart device 110A is open or closed. In further embodiments, an entry alarm smart device 110C may be configured to provide information to the system server 300 which may include times or time periods in which the access door 109 was opened, closed, locked, and/or unlocked. In still further embodiments, an entry alarm smart device 110C may be configured to prevent an alarm from being created, such as for a time period, if the door 109 governed by the door lock smart device 110A is opened while the entry alarm smart device 110C is active or armed.

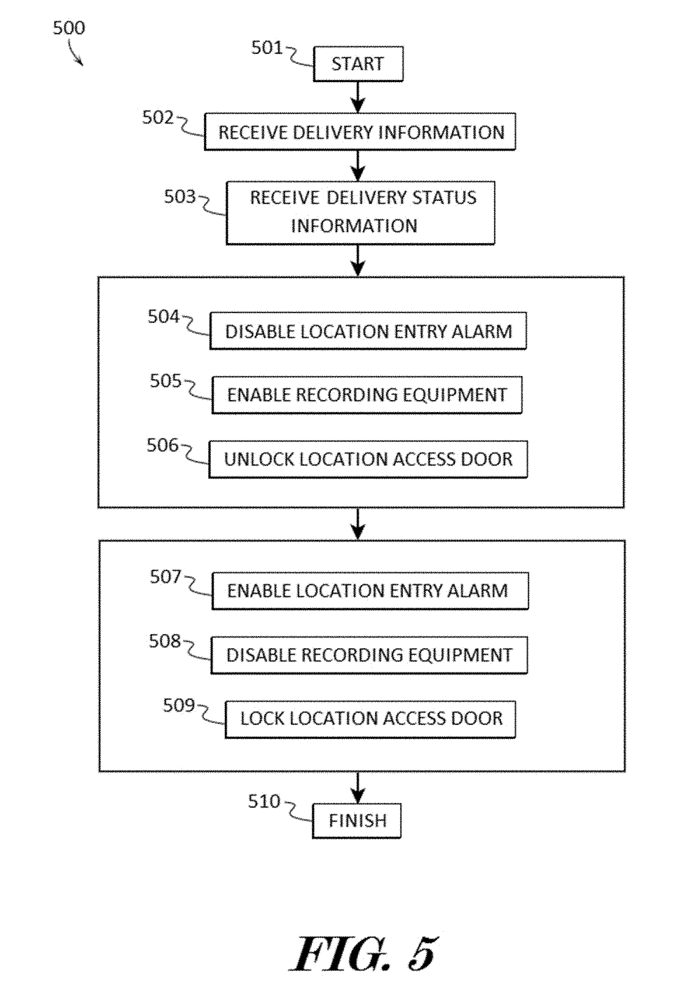

FIG. 5 depicts a block diagram of an example of a method of providing location entry for secure package delivery (“the method”) 500 according to various embodiments described herein. Referring also to FIGS. 1 and 2, the method 500 may be used to allow a delivery agent 102 of a delivery vendor 107 to deliver a package 108 securely into the delivery location 106 solving the loss of time and fuel cost to the delivery vendor 107 from having to make multiple delivery attempts if the package recipient user 101 is not available to receive the package 108 and/or to allow the package to remain out of reach from a thief thereby adding a convenience factor to the package recipient user 101.

In some embodiments, the method 500 may start, and the secure delivery application 321 of the system server 300 may receive delivery information 218 for a package 108 in step 502. The delivery information 218 may describe the package recipient user 101, describe the address or location of the delivery location 106 to which the package 108 is to be delivered, a tracking number 214 or other tracking information, and/or describe communication protocols for electronic communication by the secure delivery application 321 of the system server 300 with one or more smart devices 110, such as door lock smart devices 110A, entry alarm smart devices 110C, security camera smart devices 110B, microphones, and other recording equipment, which may be installed at the location 106 and are in contact with the data network 105 of the system 100 through a network connection 104. In some embodiments, the delivery information 218 may be provided to the secure delivery application 321 of the system server 300 by the delivery vendor 107 having a client device 400 in contact with the data network 105 of the system 100 through a network connection 104. In further embodiments, the delivery information 218 may be provided to the secure delivery application 321 by a user, such as the package recipient user 101 prior to, during, or after purchasing the contents of the package 108.

Next in step 503, the secure delivery application 321 of the system server 300 may receive delivery status information 211 which may contain information that describes the imminent delivery of the package 108 to the delivery location 106. In some embodiments, this delivery status information 211 may be provided by a delivery information device 111 operated by the delivery agent 102 when the delivery information device 111, and therefore the delivery agent 102, is at or proximate to the delivery location 106. For example, a delivery information device 111 operated by the deliver agent 102 may be a delivery information acquisition device (DIAD) commonly used by UPS delivery drivers/agents or a delivery information device 111 operated by the deliver agent 102 may be a GPS enabled tracking device which automatically updates and provides delivery status information 211 when the delivery agent's 102 vehicle is at or proximate to the delivery location 106. In a further example, the delivery status information 211 may be provided when the delivery agent 102 scans the package 108 with their delivery information device 111 immediately prior to delivery. In preferred embodiments, the secure delivery application 321 of the system server 300 may track package 108 delivery status through the delivery vendor 107 via API.

Next one or more of steps 504, 505, and 506 may be completed in any order including two or more of these steps occurring or being completed simultaneously. For example, step 504 may be completed and then steps 505 and 506 may simultaneously be completed. In another example, steps 504 and 506 may be completed and then step 505 may be completed. In another example, steps 504, 505, and 506 may be completed simultaneously or nearly simultaneously.

In some embodiments, the method 500 may include step 504 in which an entry alarm smart device 110C installed at the delivery location 106 may be disabled or otherwise operated so that an alarm is not triggered when the access door 109 to the delivery location 106 is opened. In further embodiments, the secure delivery application 321 of the system server 300 may communicate with the entry alarm smart device 110C installed at the location 106 which is in contact with the data network 105 of the system 100 through a network connection 104 using communication protocols contained in or associated with the delivery information 218 of step 502. In this manner, the communication by the secure delivery application 321 of the system server 300 may deactivate or disable an entry alarm smart device 110C so that the access door 109 to the delivery location 106 may be opened without triggering an alarm.

In some embodiments, the method 500 may include step 505 in which recording equipment comprising a security camera smart device 110B installed at the delivery location 106 may be enabled or otherwise operated so that the security camera smart device 110B may record audio and/or visual information of the area proximate to the access door 109 at the delivery location 106. In further embodiments, the secure delivery application 321 of the system server 300 may communicate with the security camera smart device 110B installed at the delivery location 106 which is in contact with the data network 105 of the system 100 through a network connection 104 using communication protocols contained in or associated with the delivery information 218 of step 502. For example, a security camera smart device 110B may be an internet enabled video camera which is able to record the audio and visual information of the area inside and/or outside the access door 109 at the delivery location 106 and the secure delivery application 321 of the system server 300 may operate the security camera smart device 110B via the data network 105.

In step 506, the access door 109 at the delivery location 106 may be unlocked. In some embodiments, the access door 109 may be engaged to a door lock smart device 110A, such as a Schlage Smart Sense Deadbolt® or the like, which may be configured to lock and unlock the access door 109 thereby allowing the access door 109 to be opened or not opened. In further embodiments, the secure delivery application 321 of the system server 300 may communicate with the door lock smart device 110A installed at the delivery location 106 which is in contact with the data network 105 of the system 100 through a network connection 104 using communication protocols contained in or associated with the delivery information 218 of step 502. In still further embodiments, when the system 100 detects that the package 108 is on route for delivery it may activate the tracking number 215 of the package 108 to enable door 109 access using the door lock smart device 110A and once the delivery agent 102 scans the package 108 with their delivery information device 111 or the security camera smart device 110B records the tracking number 215 and provides an optically obtained tracking number 216 that matches the activated tracking number 215, the secure delivery application 321 of the system server 300 may provide them access to door 109 and entry by unlocking the access door 109 via the door lock smart device 110A. The tracking number 215 of the package 108 may then be deactivated for any additional deliveries resulting in a onetime use for unlocking the access door 109. In even further embodiments, the secure delivery application 321 of the system sever 300 may confirm identification of the delivery agent 102 by authenticating the delivery information device 111, such as a delivery courier device for Uber, Lyft, UPS, USPS, FED/EX, DHL, and the like, of the delivery agent 102 for secure access to door 109. In this manner, the secure delivery application 321 of the system server 300 may identify and match package 108, delivery agent 102, and door lock smart device 110A to enable access door 109 access.

In alternative embodiments of step 506, the system 100 may include a secure lockbox type of door lock smart devices 110A that may be configured to control access to a compartment via a first access door 109 within the door lock smart device 110A in which the compartment is configured to contain a key to a second access door 109. The secure lockbox type of door lock smart devices 110A may be in contact with the secure delivery application 321 of the system server 300 through a network connection 104. The second access door 109 at the delivery location 106 may be unlocked by the delivery agent 102 utilizing the key from the secure lockbox type of door lock smart devices 110A that may be made available via the first access door 109 by the secure delivery application 321 of the system server 300 by allowing the compartment holding the key to be opened.

Once the access door 109 at the delivery location 106 is unlocked, the delivery agent 102 may open the access door 109 and place the package 108 within the location 106. Optionally, a entry alarm smart device 110C, if installed at the location 106 may be configured to not trigger an alarm when the access door 109 is opened since the entry alarm smart device 110C may be disabled or otherwise operated in optional step 504. Furthermore and optionally, a security camera smart device 110B may record the package 108 being deposited within the location 106 since the security camera smart device 110B may enabled or otherwise operated in optional step 505.

Next one or more of steps 507, 508, and 509 may be completed in any order including two or more of these steps occurring or being completed simultaneously. For example, step 509 may be completed and then steps 507 and 508 may simultaneously be completed. In another example, steps 509 and 507 may be completed and then step 508 may be completed. In another example, steps 507, 508, and 509 may be completed simultaneously or nearly simultaneously.

In some embodiments, the method 500 may include step 507 in which a entry alarm smart device 110C installed at the delivery location 106 may be enabled or otherwise operated so that an alarm is triggered when the access door 109 to the delivery location 106 is opened. In further embodiments, the secure delivery application 321 of the system server 300 may communicate with the entry alarm smart device 110C installed at the location 106 which is in contact with the data network 105 of the system 100 through a network connection 104 using communication protocols contained in or associated with the delivery information 218 of step 502. In this manner, the secure delivery application 321 of the system server 300 may activate or enable an entry alarm smart device 110C so that the access door 109 to the delivery location 106 may not be opened without triggering an alarm.

In some embodiments, the method 500 may include step 508 in which recording equipment comprising a security camera smart device 110B installed at the delivery location 106 may be disabled or otherwise operated so that the security camera smart device 110B may not record audio and/or visual information of the area proximate to the access door 109 at the delivery location 106. In further embodiments, the secure delivery application 321 of the system server 300 may communicate with the security camera smart device 110B installed at the delivery location 106 which is in contact with the data network 105 of the system 100 through a network connection 104 using communication protocols contained in or associated with the delivery information 218 of step 502.

In step 509, the access door 109 at the delivery location 106 may be locked. In some embodiments, the access door 109 may be engaged to a door lock smart device 110A, such as a Schlage Smart Sense Deadbolt® or the like, which may be configured to lock and unlock the access door 109 thereby allowing the access door 109 to be opened or not opened. In further embodiments, the secure delivery application 321 of the system server 300 may communicate with the door lock smart device 110A installed at the delivery location 106 which is in contact with the secure delivery application 321 of the system server 300 through a network connection 104 using communication protocols contained in or associated with the delivery information 218 of step 502.

In alternative embodiments of step 509, the access door 109 at the delivery location 106 may be locked by the delivery agent 102 utilizing the key from a secure lockbox type of door lock smart devices 110A that may have been made available by the secure delivery application 321 of the system server 300 by allowing the compartment holding the key to be opened. Once the access door 109 at the delivery location 106 is locked by the delivery agent 102 and the key is returned to the compartment of the secure lockbox type of door lock smart devices 110A by the delivery agent 102, the secure delivery application 321 of the system server 300 may communicate with the secure lockbox type of door lock smart devices 110A to lock the compartment to prevent access to the key within.

After completion of step 509 and optional step 507 and/or optional step 508, the method 500 may finish 510. Once step 509 is completed, any package 108 deposited within the location 106 may be securely kept in the location 106 with access to the package 108 by outside individuals prevented by the locked access door 109.

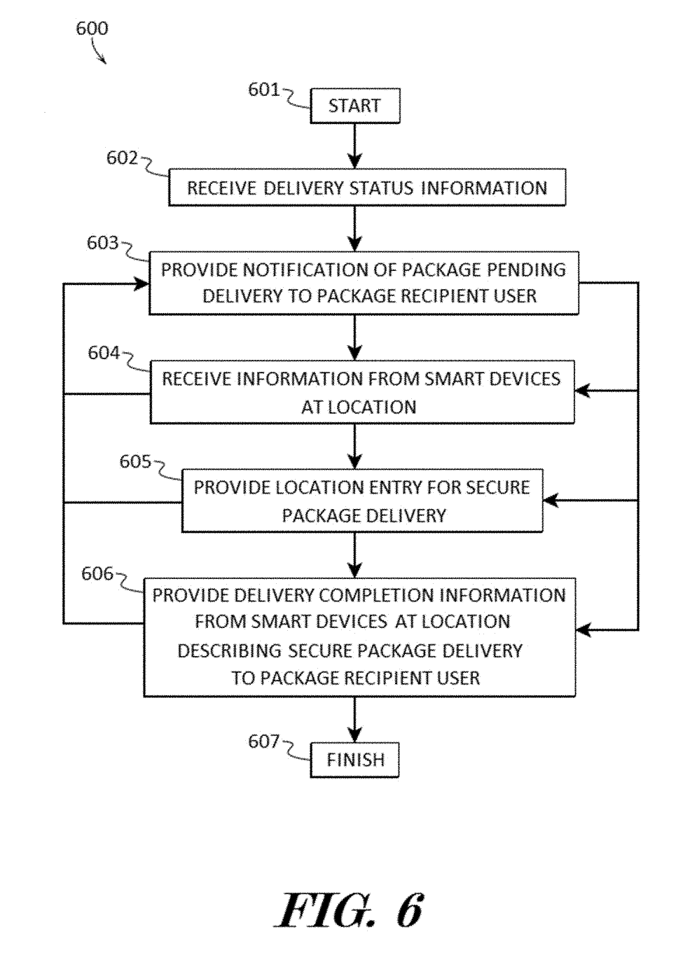

FIG. 6 illustrates a block diagram of an example of a method for notifying a package recipient user of secure package delivery (“the method”) 600 according to various embodiments described herein. Referring also to FIGS. 1 and 2, the method 600 may be used to provide information from one or more smart devices 110 at a location 106 describing the secure delivery of a package 108 to the location 106 to a client device 400 of the package recipient user 101, thereby allowing the package recipient user 101 to know that the package 108 was delivered and is secure at the location 106.

In some embodiments, the method 600 may start 601, and the secure delivery application 321 of the system server 300 may receive delivery status information 211 for a package 108 in step 602. The delivery status information 211 may include information that describes the location of the package 108, preferably when the package 108 is proximate or at the location 106 to which the package 108 is to be delivered to and therefore the imminent delivery of the package 108 to the delivery location 106. In some embodiments, this delivery status information 211 may be provided by a delivery information device 111 operated by the delivery agent 102 when the delivery information device 111, and therefore the delivery agent 102, is at or proximate to the delivery location 106. For example, the delivery information device 111 operated by the deliver agent 102 may be a delivery information acquisition device (DIAD) commonly used by UPS delivery drivers/agents or the delivery information device 111 operated by the deliver agent 102 may be a GPS enabled tracking device or a client device 400, such as a smartphone, tablet computer or the like, which automatically updates and provides delivery status information 211 when the delivery agent's 102 vehicle is at or proximate to the delivery location 106. In a further example, the delivery status information 211 may be provided when the delivery agent 102 scans the package 108 with their client device 400 immediately prior to delivery.

In step 603, a notification of pending package delivery may be provided to the client device 400 of the package recipient user 101 by the secure delivery application 321 of the system server 300. Step 603 may occur at anytime during the method 600 preferably between steps 602 and steps 606. Optionally, step 603 may be completed two or more times during the method 600 such as when new information describing package delivery is provided to the secure delivery application 321 of the system server 300. In some embodiments, the notification of package delivery may include delivery status information 211 which informs the package recipient user 101 that the delivery of a package 108 to the delivery location 106 is imminent or pending. In further embodiments, the notification of package delivery may include delivery status information 211 which informs the package recipient user 101 that the delivery of a package 108 to the delivery location 106 is occurring. In still further embodiments, the notification of package delivery may include delivery completion information 213 which informs the package recipient user 101 that the delivery of a package 108 to the delivery location 106 has occurred. In still further embodiments, the notification of package delivery may allow the package recipient user 101 to track the package 108 in route by visual GPS mapping if data is provided by delivery agent 102 and/or delivery vendor 107. The delivery status information 211 provided to the secure delivery application 321 of the system server 300 by the delivery vendor 107 may be updated as the package 108 moves from location to location or otherwise proceeds towards the delivery location 106.

In step 604, the secure delivery application 321 of the system server 300 may receive information from one or more smart devices 110 installed at the location 106. Step 604 may occur at anytime during the method 600 preferably between steps 602 and steps 606. Optionally, step 604 may be completed two or more times during the method 600 such as when new delivery status information 211 describing package pending delivery is provided to the secure delivery application 321.

In some embodiments, a smart device 110 may comprise a door lock smart device 110A which may be in contact with the secure delivery application 321 through a network connection 104 and which may be configured to provide information to the secure delivery application 321 describing the unlocking and/or unlocking of an access door 109 to which the door lock smart device 110A is configured to lock and unlock.

In some embodiments, a smart device 110 may comprise an entry alarm smart device 110C which may be in contact with the delivery application 321 of the system server 300 through a network connection 104 and which may be configured to provide information to the delivery application 321 describing the opening and/or closing of an access door 109 to which the entry alarm smart device 110C is configured to monitor.

In some embodiments, a smart device 110 may comprise a security camera smart device 110B which may be in contact with the secure delivery application 321 of the system server 300 through a network connection 104 and which may be configured to provide information to the secure delivery application 321 containing audio and/or visual recordings of the area proximate to the access door 109 thereby providing audio and/or visual recordings of the delivery of the package 108 through the access door 109.

In some embodiments, a smart device 110 may comprise a pressure pad/tray placed which may be in contact with the secure delivery application 321 of the system server 300 through a network connection 104 and which may be placed on the interior of the location 106 proximate to the access door 109 for the delivery agent 102 to place package 108 on resulting in the secure delivery application 321 registering the delivery completed.

In step 605, the secure delivery application 321 may provide location 106 entry to the delivery agent 102 for the secure delivery of the package 108. In some embodiments, location 106 entry for the location agent 102 may be accomplished according to one or more of the steps described in the method of providing location entry for secure package delivery 500 depicted in FIG. 5 and described above. Preferably, the secure delivery application 321 may communicate with a door lock smart device 110A that governs the ability to open an access door 109 at the location 106 to unlock the access door 109 so that the delivery agent 102 may open the access door 109 to deposit the package 108 within the location 106.

Finally in step 606, delivery completion information 213 describing secure delivery of the package 108 from one or more smart devices at the location 106 may be provided to the package recipient user 101. In some embodiments, the delivery completion information 213 describing secure package delivery may be communicated by a smart device 110 to the secure delivery application 321 through a network connection 104 and this information may then be communicated to the client device 400 of the package recipient user 101 via a network connection 104. Preferably, the delivery completion information 213 describing secure delivery of the package 108 may contain: video and/or audio recording by a security camera smart device 110B of a time period showing the delivery agent 102 entering and exiting the location 106 through the access door 109; video and/or audio recording by a security camera smart device 110B of the package 108 within the location 106; time and date or time period of the unlocking and locking of a door lock smart device 110A; time and date or time period of the opening and closing of a door 109 governed by a door lock smart device 110A; and/or time and date or time period of the disabling and enabling of an entry alarm smart device 110C which is configured to monitor the opening and closing of the access door 109. After step 606, the method 600 may finish 607.

Referring now to the method 500 of FIG. 5 and the method 600 of FIG. 6, in some embodiments, the secure delivery application 321 of the system server 300 may match a package identifier or tracking number 215 of a package 108 to the package recipient user 101 and to one or more smart devices 110 installed at the delivery location 106, such as door lock actuators (door lock smart devices 110A), video monitoring (security camera smart devices 110B), and security system (entry alarm smart devices 110C) to allow the delivery agent 102 access to the interior of the delivery location 106.

In some embodiments, the tracking number 215 and delivery information 218 of the package 108 may be provided to the secure delivery application 321 either directly from the e-commerce provider, delivery vendor 107 API, delivery vendor user 107A, and/or the package recipient user 101. The tracking number 215 and delivery information 218 may be harvested from the delivery vendor's 107 API after the sale is completed and package delivery information 218 is confirmed. In further embodiments, the secure delivery application 321 may monitor the location of the package 108 to see if it is on the vehicle for delivery, once it is the tracking number 215 may be authorized in the system 100 by the secure delivery application 321 to allow the access door 109 to be opened. The delivery agent 102 may initiate the final scan of the package 108 at or proximate to the access door 109, and once the secure delivery application 321 verifies and matches the tracking number 215 information of the package 108, access to the access door 109 may be provided to the delivery agent 102 to secure the package 108 inside the location 106. In preferred embodiments, one or more notifications may be sent to the client device 400 of the package recipient user 101 which may include confirmation that the location 106 has been secured by locking of an access door 109 or a key return. The package recipient user 101 may have access to view delivery completion information 213 describing the completed delivery of the package 108 through an audio/video playback of the delivery. The package tracking number 215 may then deactivated for any additional deliveries as it may be a one-time use.

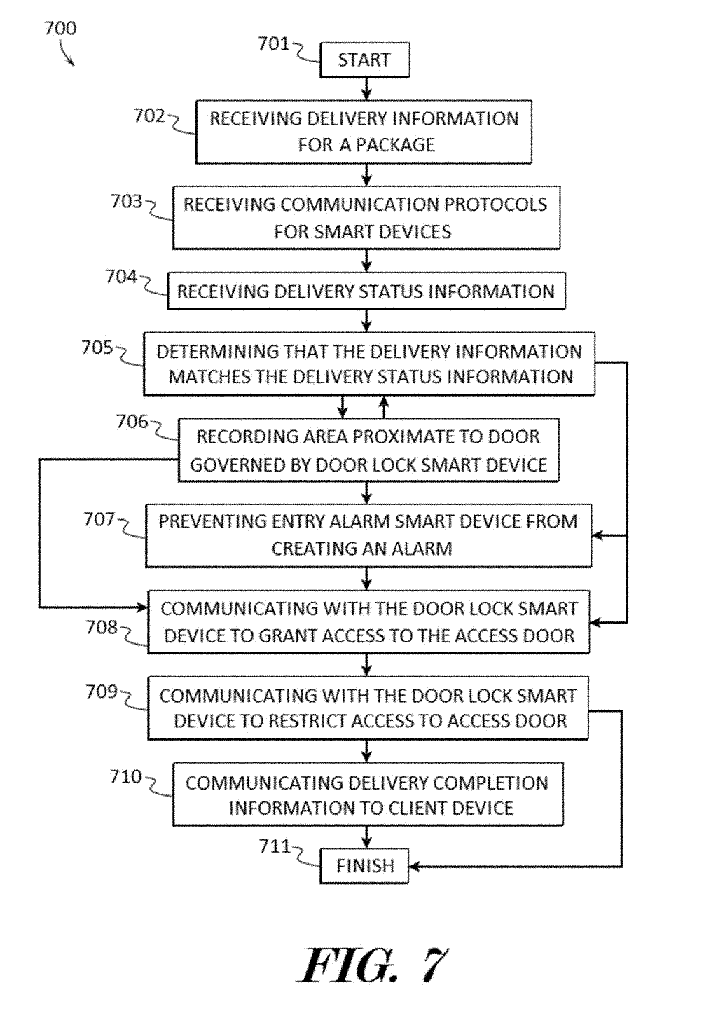

FIG. 7 depicts a block diagram of an example of a method for secure package delivery (“the method”) 700 according to various embodiments described herein. Referring also to FIGS. 1 and 2, the method 700 may be used to allow a delivery agent 102 of a delivery vendor 107 to deliver a package 108 securely into a delivery location 106 by providing temporary access to the location 106 through an access door 109 of the location 106 governed by a door lock smart device 110A.

The method 700 may start 701 and delivery information 218 may be received in step 702. In some embodiments, the delivery information 218 may be received by the secure delivery application 321 of the system server 300. In further embodiments, the delivery information 218 may include the delivery location 106 for a package 108. In still further embodiments, the delivery information 218 may include a tracking number 215 and/or a delivery vendor identifier 217 so that the package 108 may be associated with the tracking number 215 and/or a delivery vendor identifier 217 by the secure delivery application 321.

In some embodiments, the delivery information 218 may be received by the secure delivery application 321 of the system server 300 from the delivery vendor 107 having a client device 400 in contact with the data network 105 of the system 100 through a network connection 104. In further embodiments, the delivery information 218 may be received by the secure delivery application 321 from a user, such as the package recipient user 101 prior to, during, or after purchasing the contents of the package 108.

In step 703, communication protocols for one or more smart devices 110 at the location 106 may be received. In some embodiments, the communication protocols may be received by the secure delivery application 321 of the system server 300 separately from the delivery information 218. In other embodiments, the communication protocols for one or more smart devices 110 in step 703 may be received before, after, or with the delivery information 218 received in step 702. In even further embodiments, the delivery information 218 of step 702 may include communication protocols for electronic communication by the secure delivery application 321 of the system server 300 with one or more smart devices 110, such as door lock smart devices 110A, entry alarm smart devices 110C, security camera smart devices 110B, microphones, and other recording equipment, which may be installed at the location 106.

In step 704, delivery status information 211 of the package 106 may be received. In some embodiments, the delivery status information 211 may include the location of the package 106 and/or a delivery vendor identifier 217 of the delivery agent 102 or delivery vendor 107. In further embodiments, once the delivery agent 102 is at or proximate to the location 106 to which the package 108 is to be delivered, a delivery information device 111 of the delivery agent 102 may provide this information as delivery status information 211 to the secure delivery application 321 of the system server 300. In some embodiments, the delivery information device 111 of the delivery agent 102 may provide delivery status information 211 to the secure delivery application 321 which includes the location of the package 108, a tracking number 215 of the package 108, and/or a delivery vendor identifier 217. The delivery vendor identifier 217 may be any type of information which may identify the delivery agent 102/delivery vendor 107 as the entity tasked with delivering the package 108 to the location 106.

In step 705, the secure delivery application 321 may determine if the delivery information 218 matches the delivery status information 211. In some embodiments, the secure delivery application 321 may compare the geographical location or address of the package 106 contained in the delivery information 218 to the geographical location or address of the package 106 contained in the delivery status information 211. If the geographical location or address of the package 106 contained in the delivery information 218 matches the geographical location or address of the package 106 contained in the delivery status information 211, then the secure delivery application 321 may determine that the delivery information 218 matches the delivery status information 211.

In further embodiments, the secure delivery application 321 may determine if the delivery information 218 matches the delivery status information 211 by comparing the tracking number 215 and/or delivery vendor identifier 217 of the delivery information 218 to the tracking number 215 and delivery vendor identifier 217 of the delivery status information 211. If the tracking number 215 and/or delivery vendor identifier 217 of the delivery information 218 matches the tracking number 215 and/or delivery vendor identifier 217 of the delivery status information 211, then the secure delivery application 321 may determine that the delivery information 218 matches the delivery status information 211.

Once the secure delivery application 321 determines that the delivery information 218 matches the delivery status information 211, the method 700 may continue to optional step 706, optional step 707, and/or to step 708.

In some embodiments, the method 700 may include optional step 706 in which the area proximate to the door 109 governed by a door lock smart device 110A may be recorded. Preferably, the secure delivery application 321 may communicate with a security camera smart device 110B at the delivery location 106, via the communication protocols received in step 703 and through the network connection 104, to enable the security camera smart device 110B to record the area proximate to the door 109 governed by a door lock smart device 110A at the delivery location 106. In this manner, a recording of the area proximate to the door 214 governed by the door lock smart device 110A may be created in response to receiving, from the delivery information device 111, the delivery status information 211 of the package 106.

In further embodiments, the recording of the area proximate to the door 214 may include a recording of the tracking number 215, such as a barcode, QR code, alphanumeric string, or the like, which may be printed on the package 106. By recording the tracking number 215, the security camera smart device 110B may create an optically obtained tracking number 216. This optically obtained tracking number 216 may be used as delivery status information 211 and the method 700 may return to step 705 and the secure delivery application 321 may compare the optically obtained tracking number 216 to the tracking number 215 associated with the package 106 in the delivery information 218. If the optically obtained tracking number 216 of the delivery status information 211 matches the tracking number 215 of the delivery information 218, then the method 700 may continue to optional step 707 and/or step 708 in which the secure delivery application 321 may communicate with the door lock smart device 110A to enable access to the door 109 governed by the door lock smart device 110A.

In some embodiments, the method 700 may include optional step 707 in which an entry alarm smart device 110C may be prevented from creating an alarm if the access door 109 governed by the door lock smart device 110A is opened. The secure delivery application 321 may communicate with the entry alarm smart device 110C, via the communication protocols received in step 703, to direct or prevent the entry alarm smart device 110C from creating an alarm if the access door 109 governed by the door lock smart device 110A is opened. In preferred embodiments, the entry alarm smart device 110C may be prevented from creating an alarm for a time period, such as two, five, ten, fifteen, or any other number of minutes, if the access door 109 governed by the door lock smart device 110A is opened. In further embodiments, the entry alarm smart device 110C may be prevented from creating an alarm for a time period and the time period may end when the access door 109 is opened and/or closed as detected by the door lock smart device 110A and/or an entry alarm smart device 110C.

In step 708, the secure delivery application 321 may communicate with the door lock smart device 110A to enable access to the door 109 governed by the door lock smart device 110A. The secure delivery application 321 may communicate with the door lock smart device 110A, via the communication protocols received in step 703, to enable or direct the door lock smart device 110A to unlock the access to the door 109 to the location 106 in response to the package 106 being proximate to the delivery location 106 as determined in step 705.

In step 709, the secure delivery application 321 may communicate with the door lock smart device 110A to restrict access to the door 109 governed by the door lock smart device 110A. The secure delivery application 321 may communicate with the door lock smart device 110A, via the communication protocols received in step 703, to enable or direct the door lock smart device 110A to lock the access to the door 109 to the location 106 thereby restricting access to the door 109 governed by the door lock smart device 110A. In some embodiments, step 709 may be completed after a time period, such as two minutes, five minute, ten minutes, or any other number of minutes after step 708 has been completed. In other embodiments, step 709 may be completed after the access door 109 has be opened and/or closed as determined by the door lock smart device 110A and/or entry alarm smart device 110C. Optionally, after step 709 the method may finish 711 or continue to optional step 710.

In some embodiments, the method 700 may include optional step 710 in which delivery completion information 213 may be communicated to a client device 400 of the package recipient user 101 by the secure delivery application 321. Preferably, delivery completion information 213 may be provided to the secure delivery application 321 by a delivery information device 111 and/or a smart device 110, such as a door lock smart device 110A, security camera smart device 110B, and/or an entry alarm smart device 110C. In some embodiments, the delivery completion information 213 may be provided by the door lock smart device 110A and may include information describing the opening and closing of the door 109 which the door lock smart device 110A controls access to. In further embodiments, the delivery completion information 213 may be provided by the entry alarm smart device 110C and may include information describing the opening and closing of the door 109 which the door lock smart device 110A controls access to. In further embodiments, the delivery completion information 213 may be provided by a security camera smart device 110B and may include a recording of the area proximate to the door 214 governed by the door lock smart device 110A. In still further embodiments, the delivery completion information 213 may be provided by the entry alarm smart device 110C and/or the door lock smart device 110A and may include the time the door 109 governed by the door lock smart device 110A was opened and the time the door 109 governed by the door lock smart device 110A was closed. After optional step 710, the method 700 may finish 711.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A secure package delivery system, the system comprising:
a door lock smart device in communication with a system server;
a delivery information device in communication with the system server;
a client device in communication with the system server;
wherein the delivery information device is configured to provide delivery status information of a package to the system server;
wherein the door lock smart device is configured to:
i. govern access to a door; and
ii. provide information describing the opening and closing of the door to the system server;
wherein the system server is configured to:
i. in response to receiving, from the delivery information device, the delivery status information of the package, communicate with the door lock smart device to enable access to the door governed by the door lock smart device; and
ii. communicate delivery completion information which includes information describing the opening and closing of the door to the client device.

2. The system of claim 1, wherein the server communicates with the door lock smart device to enable access to the door governed by the door lock smart device for period of time in response to receiving, from the delivery information device, the delivery status information of the package.

3. The system of claim 1, further comprising a security camera smart device in communication with the system server; wherein the security camera smart device is configured to create a recording of an area proximate to the door governed by the door lock smart device; wherein the security camera smart device is configured to provide the recording to the server.

4. The system of claim 3, wherein the delivery completion information includes the recording of the area proximate to the door governed by the door lock smart device.

5. The system of claim 4, wherein the server communicates with the security camera smart device to enable the security camera smart device to create a recording of the area proximate to the door governed by the door lock smart device in response to receiving, from the delivery information device, the delivery status information of the package.

6. The system of claim 3, wherein the package is associated with a tracking number, and wherein the security camera smart device is configured to record the package to provide an optically obtained tracking number to the server, and wherein the server communicates with the door lock smart device to enable access to the door governed by the door lock smart device if the optically obtained tracking number matches the associated tracking number.

7. The system of claim 1, further comprising an entry alarm smart device in communication with the system server; wherein the entry alarm smart device is configured to determine if the door governed by the door lock smart device is open or closed; wherein the entry alarm smart device is configured to create an alarm if the door governed by the door lock smart device is opened; and wherein the server in response to receiving, from the delivery information device, the delivery status information of the package prevents the entry alarm smart device from creating an alarm for a time period if the door governed by the door lock smart device is opened.

8. The system of claim 6, wherein the time period is ended when the door is opened and then closed.

9. The system of claim 6, wherein the delivery completion information includes the time the door governed by the door lock smart device was opened and the time the door governed by the door lock smart device was closed.

10. The system of claim 1, wherein the package is associated with a tracking number and a delivery vendor identifier, and wherein the server communicates with the door lock smart device to enable access to the door governed by the door lock smart device if the delivery status information of the package provided by the delivery information device comprises the tracking number and a delivery vendor identifier associated with the package.

11. A secure package delivery method, the method comprising:
receiving delivery information which includes the delivery location for a package;
receiving communication protocols for a door lock smart device which controls access to an access door at the delivery location;
receiving delivery status information which includes the location of the package;
determining that the delivery information matches the delivery status information;
communicating, via the received communication protocols, with the door lock smart device to grant access to the access door in response to the package being proximate to the delivery location; and
communicating, via the received communication protocols, with the door lock smart device to restrict access to the access door.

12. The method of claim 11, further comprising the step of communicating delivery completion information to a client device which includes information describing the opening and closing of the door which the door lock smart device controls access to.

13. The method of claim 11, further comprising the step of creating a recording of an area proximate to the door governed by the door lock smart device

14. The method of claim 13, further comprising the step of communicating delivery completion information to a client device, wherein the delivery completion information includes information describing the opening and closing of the door which the door lock smart device controls access to, and wherein the delivery completion information includes the recording of the area proximate to the door governed by the door lock smart device.

15. The method of claim 13, wherein the recording of the area proximate to the door governed by the door lock smart device is created in response to receiving, from the delivery information device, the delivery status information of the package.

16. The method of claim 13, wherein the recording of the area proximate to the door governed by the door lock smart device is used to generate an optically obtained tracking number, wherein access to the door governed by the door lock smart device is enabled if the optically obtained tracking number matches a tracking number associated with the package.

17. The method of claim 11, further comprising the step of preventing an entry alarm smart device from creating an alarm for a time period when the door governed by the door lock smart device is opened.

18. The method of claim 17, wherein the time period is ended when the door is opened and then closed.

19. The method of claim 12, wherein the delivery completion information includes the time the door governed by the door lock smart device was opened and the time the door governed by the door lock smart device was closed.

20. The method of claim 11, wherein the delivery information includes a tracking number and a delivery vendor identifier, and wherein the delivery status information includes a tracking number and a delivery vendor identifier.
